(19) United States
(12) Patent Application Publication
(10) Pub. No.: US 2019/0313182 A1
(43) Pub. Date: Oct. 10, 2019

(54) POP-UP SPEAKER

(71) Applicant: Robert Louis Fils, Los Gatos, CA (US)

(72) Inventor: Robert Louis Fils, Los Gatos, CA (US)

(21) Appl. No.: 15/949,226

(22) Filed: Apr. 10, 2018

(51) Int. Cl. H04R 1/34; H04R 3/14; H04R 1/24; H04R 1/02

(52) U.S. Cl. CPC H04R 1/345; H04R 3/14; H04R 2420/07; H04R 1/025; H04R 1/24

(57) ABSTRACT

A speaker comprises an extendable feature configured to extend from a speaker body. The extendable feature is configured to reflect sound from the speaker when the extendable feature is in an extended position. The speaker body remains in a fixed position when the extendable feature moves to the extended position.

### FIELD OF THE INVENTION

The present invention relates to speakers and speaker systems. More particularly, the present invention relates to a speaker and speaker system comprising a raisable face for reflecting sound from a speaker.

### BACKGROUND OF THE INVENTION

It is often desirable for a user to listen to music or sound in various locations, such as, outside, by the pool or a wet environment or while performing an activity. Speakers and speaker systems enable multiple users to simultaneously enjoy music while spending time together. However, due to the sensitive nature of the electronics, a speaker and speaker system must be sufficiently protected so that it is not damaged during outside use. Additionally, wind and/or other uncontrollable environmental sounds may interfere with music from the speaker and dilute the listening experience for the users.

### SUMMARY OF THE INVENTION

Embodiments of the present invention are directed to a speaker that comprises an extendable face configured to extend from a speaker body. The extendable face is configured to reflect sound from the speaker when the extendable face is in an extended position.

In one aspect, a speaker comprises a speaker body, a speaker face positioned within the speaker body for emitting sound from the speaker, and an extendable face extendable from the speaker body, wherein the extendable face is configured to reflect sound from the speaker face in the extended position. In some embodiments, the extendable face surrounds the speaker face. Alternatively, in some embodiments, the extendable face comprises an opening for directing the sound emitting from the speaker. In some embodiments, the extendable face comprises one or more channels for directing a flow of sound from the speaker. In some embodiments, the extendable face comprises a cylinder shape. In some embodiments, the speaker is configured to be mounted within an exterior housing such that the speaker face is mounted flush to the exterior housing. In some of these embodiments, the extendable face is configured to extend up from the exterior housing in the extended position. In some embodiments, the speaker is ingress protection rated. In some embodiments, the speaker is configured to wirelessly connect to an electronic device. In some embodiments, the speaker comprises one or more crossovers for adjusting the frequencies received by the speaker. In some embodiments, the speaker body is configured to hold a plurality of speakers. In some of these embodiments, the plurality of speakers comprise one or more of a full range speaker and a tweeter. In some embodiments, the speaker body and the speaker face are fixed.

In another aspect, a speaker system comprises a speaker housing for housing the speaker, a speaker face for emitting sound from the speaker, an extendable feature movable between an extended position outside of the speaker housing and a retracted position within the speaker housing, wherein the extendable feature is configured to reflect sound from the speaker face in the extended position and one or more accessory cables configured to connect the speaker system to an external device. In some embodiments, the extendable feature surrounds the speaker face. In some embodiments, the extendable feature comprises an opening for directing the sound emitting from the speaker. In some embodiments, the extendable feature comprises one or more channels for directing a flow of sound from the speaker. In further embodiments, the extendable feature comprises a cylinder shape. In some embodiments, the speaker is configured to be mounted within an exterior housing such that the speaker body is mounted flush to the exterior housing. In some embodiments, the extendable feature is configured to extend up from the exterior housing in the extended position. In some embodiments, the speaker system is ingress protection rated. In some embodiments, the external device comprises one of an electronic device, a radio, an amplifier and a receiver. In further embodiments, the speaker system is configured to wirelessly connect to an electronic device. In some embodiments, the speaker system comprises one or more crossovers for adjusting the frequencies received by the speaker. In some embodiments, the speaker housing is configured to hold a plurality of speakers. In some of these embodiments, the plurality of speakers comprise one or more of a full range speaker and a tweeter. In some embodiments, the speaker housing and the speaker face are fixed.

In a further aspect, a method of operating a speaker comprises extending an extendable feature of the speaker from a retracted to an extended position, wherein the extendable face extends from a body of the speaker in the extended position and playing music through the speaker, wherein the extendable feature is configured to reflect sound from the speaker face in the extended position. In some embodiments, the method comprises connecting the speaker to an electronic device. In some embodiments, the speaker is wirelessly connected to the electronic device. In some embodiments, the body of the speaker and the speaker face are fixed.

In still a further aspect, a speaker comprises a speaker body, a speaker face positioned within a lower portion of the speaker body for emitting sound from the speaker and a cylinder extendable from the speaker body, wherein the cylinder is configured to reflect sound from the speaker face in the extended position. In some embodiments, the cylinder comprises a cylinder cap for protecting the speaker face when the cylinder is in a retracted position. In further embodiments, the cylinder comprises one or more slits for projecting sound from the speaker. In some embodiments, the cylinder is rotatable. In some embodiments, the speaker is configured to be mounted within an exterior housing such that the speaker body and cap are flush to the exterior housing when the cylinder is in a retracted position. In some embodiments, the speaker is ingress protection rated. In some embodiments, the speaker is configured to connect to an external device. In some of these embodiments, the external device comprises one of an electronic device, a radio, an amplifier and a receiver. In some embodiments, the speaker system is configured to wirelessly connect to the electronic device. In some embodiments, the speaker comprises one or more crossovers for adjusting the frequencies received by the speaker. In some embodiments, the speaker body is configured to hold a plurality of speakers. In some of these embodiments, the plurality of speakers comprise one or more of a full range speaker and a tweeter. In some embodiments, the speaker body and the speaker face are fixed.

### BRIEF DESCRIPTION OF THE DRAWINGS

FIG. 1 illustrates a speaker and speaker system in accordance with some embodiments.

FIG. 2 illustrates a speaker and speaker system in accordance with some embodiments.

FIG. 3 illustrates a speaker and speaker system in accordance with some embodiments.

FIG. 4 illustrates a speaker and speaker system in accordance with some embodiments.

FIG. 5 illustrates a method of operating a speaker system in accordance with some embodiments.

FIGS. 6A-6C illustrate a speaker and speaker system in accordance with some embodiments.

FIG. 7 illustrates a speaker and speaker system in accordance with some embodiments.

FIG. 8 illustrates a speaker and/or speaker system 800 and speaker housing and/or a speaker body 801 configured to hold a plurality of speakers.

### DETAILED DESCRIPTION OF THE PREFERRED EMBODIMENT

In the following description, numerous details and alternatives are set forth for purpose of explanation. However, one of ordinary skill in the art will realize the invention is able to be practiced without the use of these specific details. Particularly, one of ordinary skill in the art will recognize that some embodiments of the invention are able to be practiced with other electronic systems and components. Throughout the description similar components are similarly marked in order to aid comprehension.

Embodiments of the present invention are directed to a speaker that comprises an extendable face configured to extend from a speaker body. The extendable face is configured to reflect sound from the speaker when the extendable face is in an extended position.

Referring now to FIG. 1, a speaker is shown therein. The speaker 100 comprises a speaker body 101, a speaker face 103 at a top of the speaker body 101 and an extendable face 105. In some embodiments, the speaker also emits sound from the side or sides of the speaker body 101. The extendable face 105 is configured to extend from and retract into the speaker body 101. The speaker body 101 remains in a fixed position when the extendable face 105 moves to the extended position.

When the extendable face 105 is in the extended position it is configured to reflect sound from the speaker face 103. As shown within FIG. 1, the speaker 100 comprises a base 107 and one or more accessory cables 109 for coupling the speaker with an external device. For example, in some embodiments, the one or more accessory cables 109 are able to couple the speaker 100 with one or more of an electronic device, a radio, an amplifier and a receiver. In some embodiments, the speaker 100 is able to wirelessly connect to an electronic device. In some embodiments, the speaker body 101 is configured to hold a plurality of speakers. For example, in some embodiments, the plurality of speakers comprise one or more of a full range speaker and a tweeter. Particularly, the speaker body 101 is able to comprise any appropriately desired number and configurations of speakers.

FIG. 2 illustrates a speaker 200 comprising an extendable face 205, such as described above. As described above, the speaker 200 comprises a speaker body 201, a speaker face 203 at a top of the speaker body 201 and an extendable face 205. In some embodiments, the speaker also emits sound from the side or sides of the speaker body 201. The speaker 200 also comprises a base 207 and one or more accessory cables 209 for coupling the speaker with an external device. For example, in some embodiments, the one or more accessory cables 209 are able to couple the speaker 200 with one or more of an electronic device, a radio, an amplifier and a receiver. In some embodiments, the speaker 200 is able to wirelessly connect to an electronic device.

As shown within FIG. 2, the extendable face 205 is in an extended position. As described above, when the extendable face 205 is in the extended position, the extendable face 205 reflects sound from the speaker face 203. Particularly, the extendable face 205 is able to reflect the sound from the speaker face 203 such that the speaker body 201 and/or the speaker face 203 is able to remain static as sound is emitted from the speaker 200. In some embodiments, the extendable face 203 projects the sound from the speaker 200 such that the sound is amplified. The speaker body 201 remains in a fixed position when the extendable face 205 moves to the extended position.

As further shown within FIG. 2, the extendable face 205 is a cylinder shape and surrounds the speaker face 203. In this configuration, the extendable face is able to reflect sound emitting from the speaker face 203 in an upward and outward direction. This enables the speaker 200 to increase the reach of the speaker 200 such as to fill a space and/or outdoor area with sound. In some embodiments, the extendable face 205 comprises an opening for directing sound emitting from the speaker face 203 in one or more directions. In some embodiments, the speaker body 201 is configured to hold a plurality of speakers. For example, in some embodiments, the plurality of speakers comprise one or more of a full range speaker and a tweeter. Particularly, the speaker body 201 is able to comprise any appropriately desired number and configurations of speakers.

FIG. 3 illustrates a speaker 300 comprising an extendable face 305, such as described above. As described above, the speaker 300 comprises a speaker body 301, a speaker face 303 at a top of the speaker body 301 and an extendable face 305. In some embodiments, the speaker also emits sound from the side or sides of the speaker body 301. The speaker 300 also comprises a base 307 and one or more accessory cables 309 for coupling the speaker with an external device. For example, in some embodiments, the one or more accessory cables 309 are able to couple the speaker 300 with one or more of an electronic device, a radio, an amplifier and a receiver. In some embodiments, the speaker 300 is able to wirelessly connect to an electronic device. In some embodiments, the speaker body 301 is configured to hold a plurality of speakers. For example, in some embodiments, the plurality of speakers comprise one or more of a full range speaker and a tweeter. Particularly, the speaker body 301 is able to comprise any appropriately desired number and configurations of speakers.

As shown within FIG. 3, the extendable face 305 is in an extended position. As described above, when the extendable face 305 is in the extended position, the extendable face 305 reflects sound from the speaker face 303. Particularly, the extendable face 305 is able to reflect the sound from the speaker face 303 such that the speaker body 301 and/or the speaker face 303 is able to remain static as sound is emitted from the speaker 300. As shown within FIG. 3, the extendable face 305 comprises an opening for directing sound from the speaker face 303 in one or more directions. In this manner, the extendable face 305 is able to pointedly direct sound from the speaker 300. As described above, the speaker body 301 remains in a fixed position when the extendable face 305 moves to the extended position.

In some embodiments, the speaker housing and faces such as described above, are round. Alternatively, in some embodiments the speaker housing and faces are oval or another shape. Particularly, the speaker housing and faces are able to comprise any appropriately desired shape. In some embodiments, the speaker face comprises one or more channels for influencing the flow of the sound from the speakers. In further embodiments, the speakers comprise one or more crossovers for adjusting the frequencies received by the speaker. As described above, the speaker housing and/or bodies are able to hold a plurality of speakers. For example, in some embodiments, the plurality of speakers comprise one or more of a full range speaker and a tweeter. Particularly, the speaker housing and/or bodies are able to comprise any appropriately desired number and configurations of speakers.

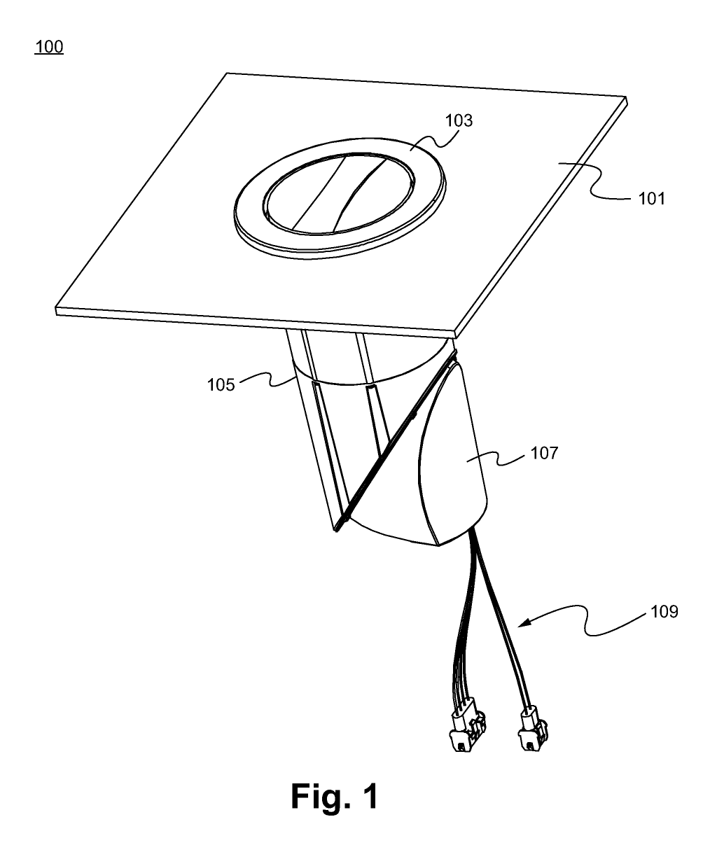

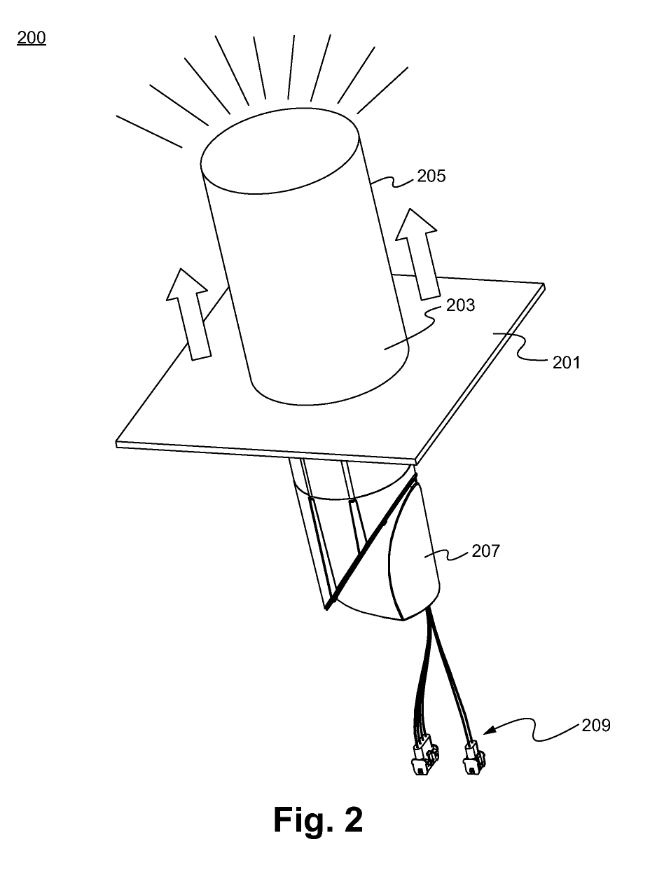

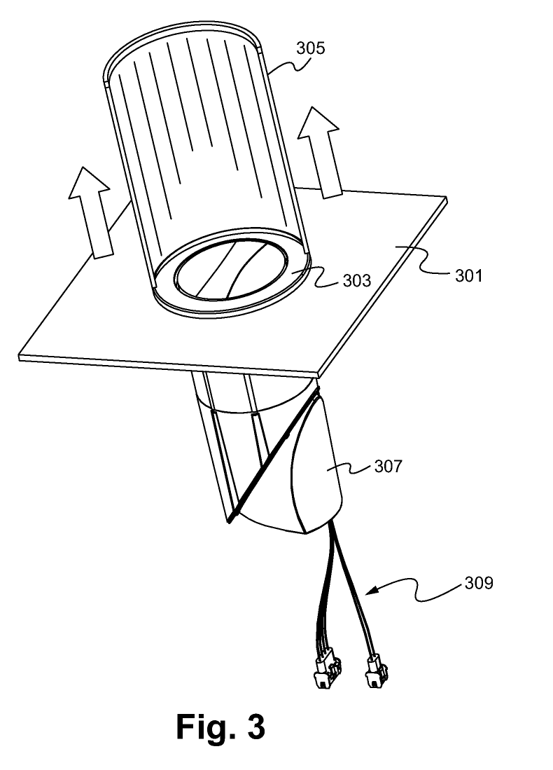

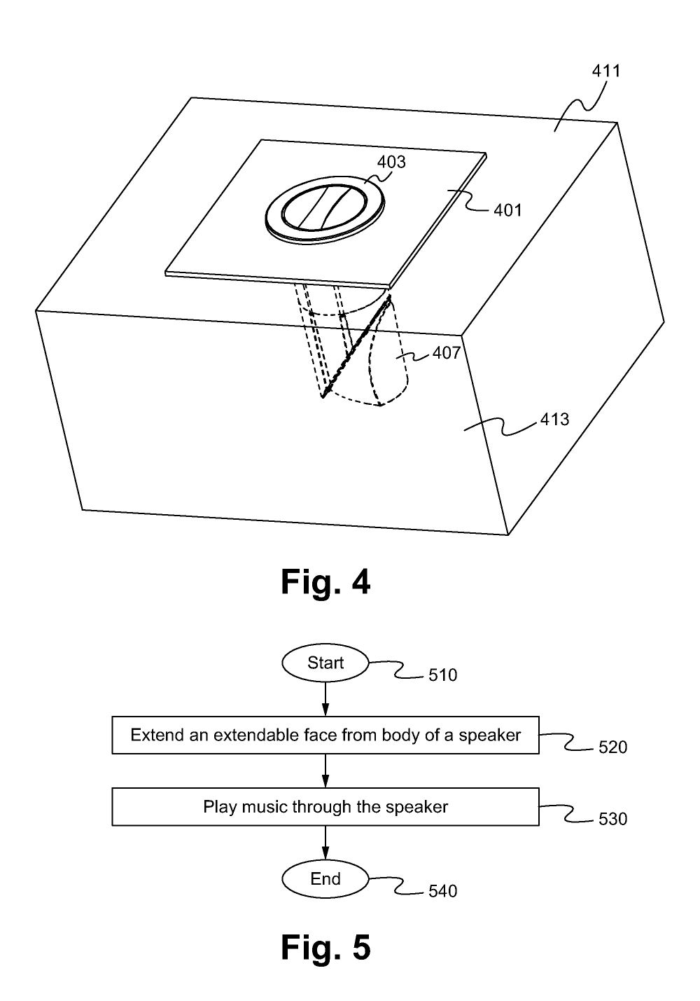

FIG. 4 illustrates a speaker mounted within an exterior housing. The speaker 400 is similar the speakers 100, 400 and 300 such as described above and comprises a speaker body 401, a speaker face 403 at a top of the speaker body 401 and an extendable face 405. In some embodiments, the speaker also emits sound from the side or sides of the speaker body 401. The speaker 400 also comprises a base 407 and one or more accessory cables for coupling the speaker with an external device. For example, in some embodiments, the one or more accessory cables 409 are able to couple the speaker 400 with one or more of an electronic device, a radio, an amplifier and a receiver. As described above, the speaker body 401 and the speaker face 403 remain in a fixed position when the extendable face 405 moves to the extended position.

As shown within FIG. 4, the speaker body 401 is mounted within the exterior housing such that the speaker face 403 is flush with a surface 411 of the exterior housing and the speaker body 407 is within an interior 413 of the exterior housing. In some embodiments, the speaker housing is located within a marine environment. For example, in some embodiments, the exterior housing is coupled to a spa, a hot tub, a pool, a boat and/or other marine environment. Particularly, the exterior housing is able to be located within any appropriately desired environment.

FIG. 5 illustrates a method of operating a speaker system. The method begins in the step 510. In the step 520 an extendable face of a speaker is extended from a retracted to an extended position. In the extended position, the extendable face extends from a body of the speaker in the extended position. Then, in the step 530, music is played through the speaker. The extendable face is configured to reflect sound from the speaker face in the extended position. In some embodiments, the method comprises connecting the speaker to an electronic device. In some embodiments, the speaker is wirelessly connected to the electronic device. The method ends in the step 550.

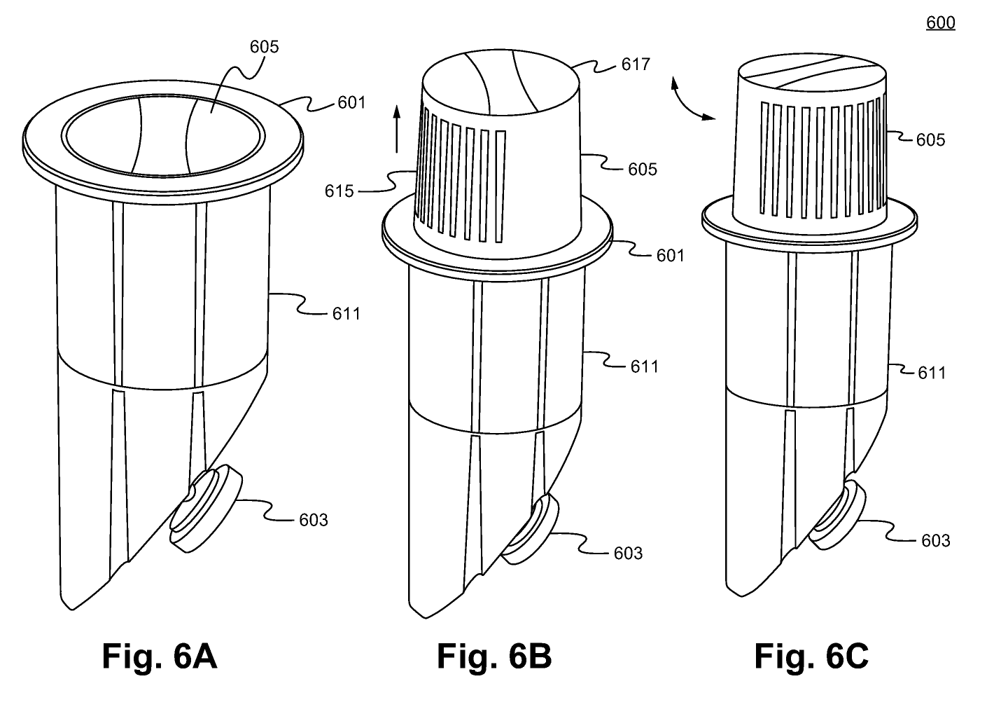

Referring now to FIGS. 6A-6C, a speaker is shown therein. The speaker 600 comprises an upper speaker body 601, an extendable cylinder 605, and a speaker face 603. As shown within FIGS. 6A-6C, the speaker face 603 is located within a lower body 620 of the speaker 600. The extendable cylinder 605 is configured to extend from and retract into the speaker body 601. When extendable cylinder 605 is in the extended position, it is configured to reflect sound from the speaker face 603. Sound travels from the speaker face 603 through the lower body 620 of the speaker 600 and out through the extendable cylinder 605 when it is in the extended position. In this manner, the speaker face 603 and speaker 600 is able to be hid below a surface and utilize the extendable cylinder 605 to channel the music to a listener. In some embodiments, such as shown within FIG. 1, speaker 600 comprises a base and one or more accessory cables for coupling the speaker with an external device. For example, in some embodiments, the one or more accessory cables are able to couple the speaker 600 with one or more of an electronic device, a radio, an amplifier and a receiver. In some embodiments, the speaker is able to wirelessly connect to an electronic device. In some embodiments, the speaker 600 is configured to hold a plurality of speakers. For example, in some embodiments, the plurality of speakers comprise one or more of a full range speaker and a tweeter. Particularly, the speaker 600 is able to comprise any appropriately desired number and configurations of speakers.

As shown within FIG. 6B, the extendable cylinder 605 is in the extended position. As described above, when the extendable cylinder 605 is in the extended position, the extendable cylinder 605 reflects sound from the speaker face 603. Particularly, the extendable cylinder 605 is able to reflect the sound from the speaker face 603 such that the speaker body 601 and/or the speaker cylinder 603 is able to remain static as sound is emitted from the speaker 600. In some embodiments, the extendable cylinder 603 projects the sound from the speaker 600 such that the sound is amplified. The speaker body 601 remains in a fixed position when the extendable cylinder 605 moves to the extended position.

As further shown within FIG. 6B, the extendable cylinder 605 comprises a cap 617 and one or more slits 615 for emitting sound from the speaker face 603. In this configuration, the extendable face is able to reflect sound emitting from the speaker face 603 to fill a space and/or outdoor area with sound. The one or more slits 615 enable a user to direct sound emitting from the speaker face 603 in one or more directions. As shown within FIG. 6C, in some embodiments, the speaker cylinder 605 is rotatable. In this manner, the speaker cylinder 605 is able to be rotated 360° to direct sound to a desired area.

The speaker 600 is able to be mounted within an exterior housing such as described above. The speaker 600 is able to be mounted such that the upper body 601 and the speaker cylinder 605 are flush to an exterior surface body of the housing when the speaker cylinder 605 is in a retracted position and the lower body 620 and the speaker face 603 are located within an interior of the exterior housing. When the speaker cylinder 605 is in the retracted position, the cylinder cap 617 is able to shield the speaker face from environmental and other intrusions. In some embodiments, the speaker housing is located within a marine environment. For example, in some embodiments, the exterior housing is coupled to a spa, a hot tub, a pool, a boat and/or other marine environment. Particularly, the exterior housing is able to be located within any appropriately desired environment.

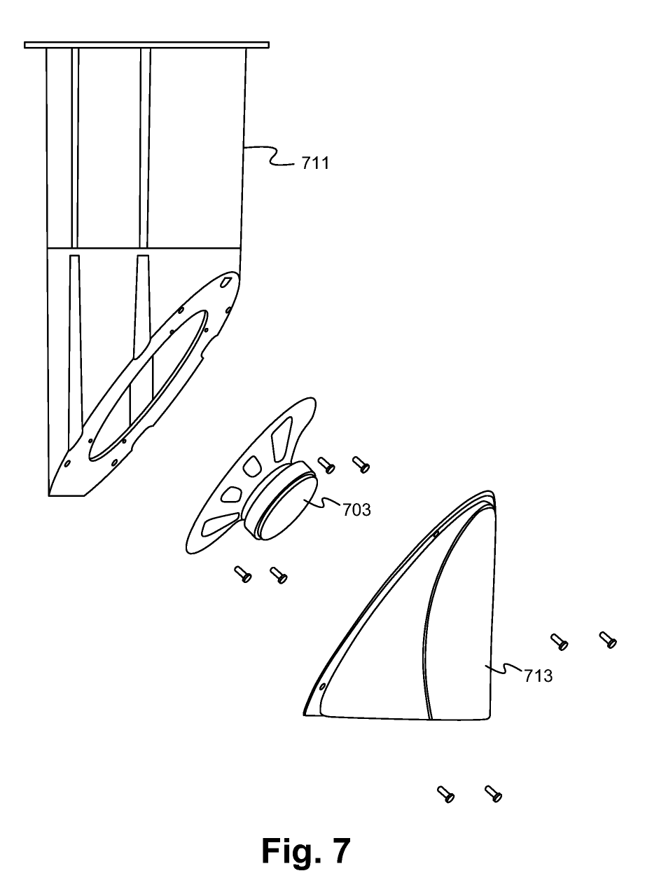

As shown within FIG. 7, in some embodiments a cover 713 is mounted over the speaker face 703 after it is connected to the lower body 711. In some embodiments, the cover 713 and the speaker face 703 are removable so that the speaker face 703 is able to be changed.

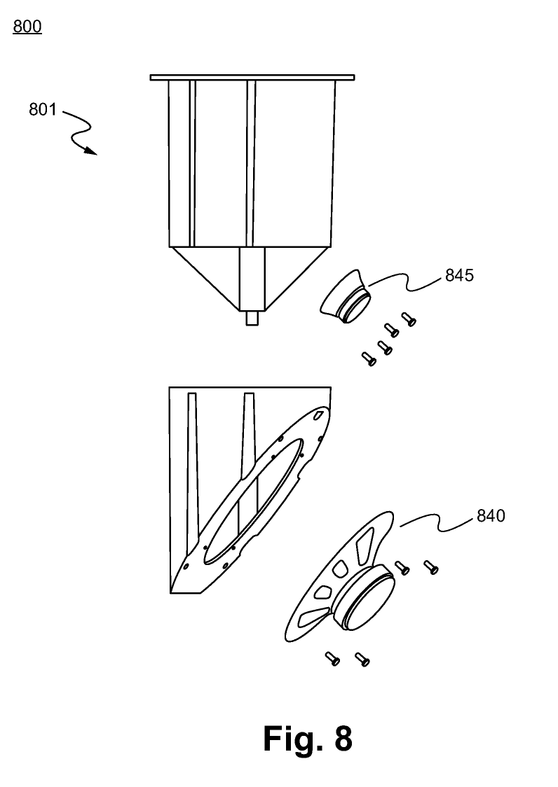

As described above, the speakers and/or speaker systems are configured to hold a plurality of speakers. FIG. 8 illustrates a speaker and/or speaker system 800 and speaker housing and/or a speaker body 801 configured to hold a plurality of speakers. As shown within FIG. 8, the plurality of speakers comprise one or more of a full range speaker 840 and a tweeter 845. However, the speaker and/or speaker system 800 is able to comprise any appropriately desired number and configurations of speakers as appropriately desired.

In some embodiments, the speaker and speaker system such as described above is ingress protection rated. For example, in some embodiments, the speaker and speaker system such as described above comprises an ingress protection rating of IPX-4 to IPX-7. However, the speaker and speaker system is able to comprise any appropriately desired ingress protection rating.

As described above, the extendable face is able to reflect the sound from the speaker face such that the speaker body and/or the speaker face is able to remain static as sound is emitted from the speaker. In some embodiments, the extendable face is a cylinder shape and surrounds the speaker face. In this configuration, the extendable face is able to reflect sound emitting from the speaker face in an upward and outward direction. This enables the speaker to increase the reach of the speaker such as to fill a space and/or outdoor area with sound. Alternatively, the extendable face comprises an opening for directing sound from the speaker face in one or more directions. As described above, the speaker face is able to comprise any appropriately desired shape and/or configuration for directing sound. As described above, the speaker face and the speaker body remain in a fixed position when the speaker face moves to an extended position.

The present invention provides an easy and convenient way to play a speaker. Particularly, a user is easily able to raise and lower and extendable face of the speaker in order to reflect sound playing from the speaker. In some embodiments, the speaker and speaker system is substantially hermetically sealed such that a user is able to use the speaker and speaker system in a wet environment such as a spa, boat, pool or other outside area without fear of damaging the speaker or speaker system. Consequently, the user is able to enjoy use of the speaker and speaker system without worrying that it may become damaged by water or environmental intrusion.

Additionally, the extendable face allows a user to direct, reflect and/or amplify sound from the speaker and speaker system to enhance an area with music. Then, when use of the speaker is no longer desired, the user is able to retract the extendable face into the speaker body where the speaker is protected from environmental intrusion, such as described above. Further, the extendable speaker in the extended position is able to protect the sound from the speaker from wind and/or other uncontrollable noises that might otherwise dilute the sound. Accordingly, the speaker and speaker system described herein has numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

1. A speaker comprising:
a. a speaker body;
b. a speaker face positioned within the speaker body for emitting sound from the speaker; and
c. an extendable face extendable from the speaker body while the speaker body and the speaker face remain stationary in a stationary position, wherein the extendable face is configured to reflect sound from the speaker face in the extended position.

2. The speaker of claim 1, wherein the extendable face surrounds the speaker face.

3. The speaker of claim 1, wherein the extendable face comprises an opening for directing the sound emitting from the speaker.

4. The speaker of claim 1, wherein the extendable face comprises one or more channels for directing a flow of sound from the speaker.

5. The speaker of claim 1, wherein the extendable face comprises a cylinder shape.

6. The speaker of claim 1, wherein the speaker is configured to be mounted within an exterior housing such that the speaker face is mounted flush to the exterior housing.

7. The speaker of claim 6, wherein the extendable face is configured to extend up from the exterior housing in the extended position.

8. The speaker of claim 1, wherein the speaker is ingress protection rated.

9. The speaker of claim 1, wherein the speaker is configured to wirelessly connect to an electronic device.

10. The speaker of claim 1, wherein the speaker body and the speaker face are fixed in the stationary position.

11. The speaker of claim 1, wherein the speaker comprises one or more crossovers for adjusting the frequencies received by the speaker.

12. The speaker of claim 1, wherein the speaker body is configured to hold a plurality of speakers.

13. The speaker of claim 12, wherein the plurality of speakers comprise one or more of a full range speaker and a tweeter.

14. A speaker system comprising:
a. a speaker housing for housing the speaker;
b. a speaker face for emitting sound from the speaker;
c. an extendable feature movable between an extended position outside of the speaker housing and a retracted position within the speaker housing, wherein the extendable feature is configured to reflect sound from the speaker face in the extended position and further wherein the speaker housing and the speaker face remain stationary in a stationary position while the extendable feature is in the extended position; and
d. one or more accessory cables configured to connect the speaker system to an external device.

15. The speaker system of claim 14, wherein the extendable feature surrounds the speaker face.

16. The speaker system of claim 14, wherein the extendable feature comprises an opening for directing the sound emitting from the speaker.

17. The speaker system of claim 14, wherein the extendable feature comprises one or more channels for directing a flow of sound from the speaker.

18. The speaker system of claim 14, wherein the extendable feature comprises a cylinder shape.

19. The speaker system of claim 14, wherein the speaker is configured to be mounted within an exterior housing such that the speaker body is mounted flush to the exterior housing.

20. The speaker system of claim 19, wherein the extendable feature is configured to extend up from the exterior housing in the extended position.

21. The speaker system of claim 14, wherein the speaker system is ingress protection rated.

22. The speaker system of claim 14, wherein the external device comprises one of an electronic device, a radio, an amplifier and a receiver.

23. The speaker system of claim 14, wherein the speaker system is configured to wirelessly connect to an electronic device.

24. The speaker system of claim 14, wherein the speaker system comprises one or more crossovers for adjusting the frequencies received by the speaker.

25. The speaker system of claim 14, wherein the speaker housing is configured to hold a plurality of speakers.

26. The speaker system of claim 25, wherein the speakers comprise one or more of a full range speaker and a tweeter.

27. The speaker system of claim 14, wherein the speaker housing and the speaker face are fixed in the stationary position.

28. A method of operating a speaker comprising:
a. extending an extendable feature of the speaker from a retracted to an extended position, wherein the extendable feature extends from a body of the speaker in the extended position while the speaker and a speaker face remain stationary in a stationary position; and
b. playing music through the speaker, wherein the extendable feature is configured to reflect sound from the speaker face in the extended position.

29. The method of claim 28, further comprising connecting the speaker to an electronic device.

30. The method of claim 29, wherein the speaker is wirelessly connected to the electronic device.

31. The method of claim 28, wherein the body of the speaker and the speaker face are fixed.

32. A speaker comprising:
a. a speaker body;
b. a speaker face positioned within a lower portion of the speaker body for emitting sound from the speaker; and
c. a cylinder extendable from the speaker body while the speaker body and the speaker face remain stationary in a stationary position, wherein the cylinder is configured to reflect sound from the speaker face in the extended position.

33. The speaker of claim 32, wherein the cylinder comprises a cylinder cap for protecting the speaker face when the cylinder is in a retracted position.

34. The speaker of claim 32, wherein the cylinder comprises one or more slits for projecting sound from the speaker.

35. The speaker of claim 32, wherein the cylinder is rotatable.

36. The speaker of claim 32, wherein the speaker is configured to be mounted within an exterior housing such that the speaker body and cap are flush to the exterior housing when the cylinder is in a retracted position.

37. The speaker of claim 32, wherein the speaker is ingress protection rated.

38. The speaker of claim 32, wherein the speaker is configured to connect to an external device.

39. The speaker of claim 38, wherein the external device comprises one of an electronic device, a radio, an amplifier and a receiver.

40. The speaker of claim 39, wherein the speaker system is configured to wirelessly connect to the electronic device.

41. The speaker of claim 32, wherein the speaker comprises one or more crossovers for adjusting the frequencies received by the speaker.

42. The speaker of claim 32, wherein speaker body is configured to hold a plurality of speakers.

43. The speaker of claim 42, wherein the plurality of speakers comprise one or more of a full range speaker and a tweeter.

44. The speaker of claim 32 wherein the speaker body and the speaker face are fixed in the stationary position.
